(19) United States
(12) Patent Application Publication
(10) Pub. No.: US 2010/0115137 A1
(43) Pub. Date: May 6, 2010

(54) Data compression method and data communication system utilizing the same

(75) Inventors: Byeong Deok Kim, Suwon-si (KR); Sung Jo Oh, Suwon-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/590,275

(22) Filed: Nov. 4, 2009

(30) Foreign Application Priority Data
Nov. 5, 2008 (KR) 10-2008-0109185

(51) Int. Cl. G06F 15/16

(52) U.S. Cl. 709/247

(57) ABSTRACT

A data compression method and data communication system utilizing the same includes: a sender apparatus that compares, in response to input of data to be sent, the input data with the previously sent data in storage. The sender apparatus produces, when a data item repeated in the input data and previously sent data is found, delta data by excluding the repeated data item from the input data. The sender apparatus represents the delta data in a transport format, and transmits the delta data. The system includes a receiver apparatus that receives the data in a transport format. The receiver apparatus adds, when delta data is present in the received data, a repeated data item to the delta data, and recovers the original data. The sender apparatus sends and receives data to and from the receiver apparatus through a text-based protocol.

### CROSS-REFERENCE TO RELATED APPLICATION(S) AND CLAIM OF PRIORITY

The present application is related to and claims priority to an application entitled “DATA COMPRESSION METHOD AND DATA COMMUNICATION SYSTEM UTILIZING THE SAME” filed in the Korean Intellectual Property Office on Nov. 5, 2008 and assigned Serial No. 10-2008-0109185, the contents of which are incorporated herein by reference.

### TECHNICAL FIELD OF THE INVENTION

The present invention relates to a data compression method and a data communication system utilizing the same.

### BACKGROUND OF THE INVENTION

Communication is performed to send and receive data between devices. During communication, devices may act as servers (or hosts) and clients, or may act as masters and slaves. In client-server communication, a client receives a request from a user and sends the request to a server through the network, the server managing a database provides requested data to the client, and the client delivers the requested data to the user. Two devices communicate with each other according to preset communication protocols.

Communication protocols may be classified in various ways. Based on human readability of messages, communication protocols may be grouped into bit-based protocols and text-based protocols. In a bit-based protocol, a message is composed using bit patterns. In a text-based protocol, the header of a message, required to carry real data, is coded using text in, for example, HTML (HyperText Markup Language) or XML (Extensible Markup Language).

Because of text coding, a message of a text-based protocol tends to be bulkier than that of a bit-based protocol. In the case where frequent data transmission is required or a large amount of data is to be transmitted, the use of a text-based protocol may cause a processing load on a server and client, resulting in high communication costs and low network efficiency. Hence, it is necessary to provide a means to improve the efficiency of a network employing a text-based protocol without an undue processing burden.

### SUMMARY OF THE INVENTION

To address the above-discussed deficiencies of the prior art, it is a primary object to provide a data compression method and a data communication system utilizing the same.

In accordance with an exemplary embodiment of the present invention, a data compression method includes: comparing, in response to input of data to be sent using a text-based protocol, the input data with the previously sent data in storage; producing, when a data item repeated in the input data and previously sent data is found, delta data by excluding the repeated data item from the input data; checking whether the produced delta data is listed in index information; and representing, when the produced delta data is listed in the index information, the delta data by a matching index of the index information. The data compression method further can include: checking whether protocol update information is present; and updating, when protocol update information is present, a protocol associated with the protocol update information. The data compression method further can include: analyzing, before comparing, the pattern of the input data; and converting the input data into a form usable for a delta data protocol.

In accordance with an exemplary embodiment of the present invention, a data communication system includes: a sender apparatus comparing, in response to input of data to be sent, the input data with the previously sent data in storage, producing, when a data item repeated in the input data and previously sent data is found, delta data by excluding the repeated data item from the input data, representing the delta data in a transport format, and transmitting the delta data; and a receiver apparatus receiving data in a transport format, adding, when delta data is present in the received data, a repeated data item to the delta data, and recovering the original data, wherein the sender apparatus sends and receives data to and from the receiver apparatus through a text-based protocol. The sender apparatus can be a server and the receiver apparatus can be a client. Additionally, the sender apparatus can be a client and the receiver apparatus can be a server. An application on the sender apparatus and another application on the receiver apparatus can communicate with each other through a multi-layer protocol stack, and a delta data protocol resides in the application layer of the multi-layer protocol stack. The application layer can include an application protocol and the delta data protocol below the application protocol.

Hereinabove, the features and advantages of the present invention are described in a relatively broad perspective to help those skilled in the art understand the present invention. Other features and advantages constituting the subject matter of the present invention will be more apparent from the following detailed description.

In a feature of the present invention, the amount of data transmitted through wired and wireless networks can be reduced, thereby reducing processing loads and enhancing network efficiency. In addition, data transmission is performed on the basis of changes (deltas), and hence a text-based protocol may be used without increasing network traffic and costs of a service provider.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of a protocol hierarchy according to an exemplary embodiment of the present invention;

FIG. 2 illustrates a block diagram of a smart protocol unit driving a smart protocol in the protocol hierarchy of FIG. 1;

FIG. 3 illustrates a sequence diagram for a procedure for data communication between a server and client according to embodiments of the present disclosure;

FIG. 4 illustrates a flow chart for a procedure of data compression performed by the smart protocol unit at the sender according to embodiments of the present disclosure; and

FIG. 5 illustrates a flow chart for a procedure of data restoration performed by the smart protocol unit at the receiver according to embodiments of the present disclosure.

### DETAILED DESCRIPTION OF THE INVENTION

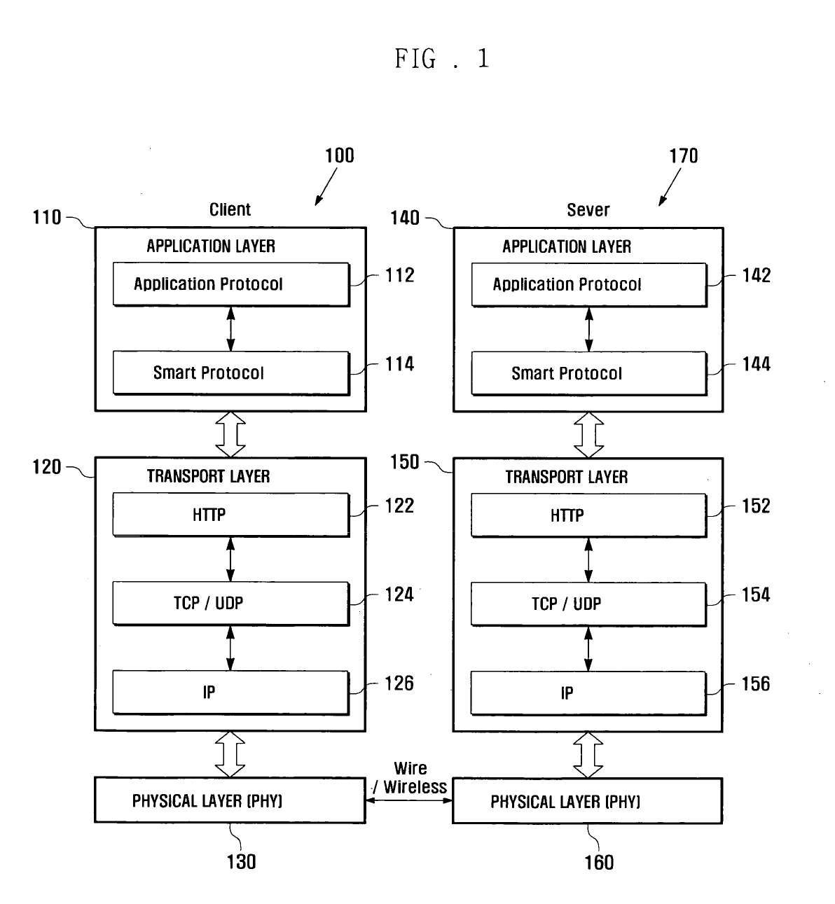

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

In the description, a communication protocol based on SyncML (Synchronization Markup Language) is described as an example of a text-based protocol, which may increase processing loads and network traffic during data communication. SyncML is an international standard proposed for data synchronization in distributed environments. To ensure data synchronization between data sets used by two or more application programs, whenever one application program changes its data set by inputting, updating and deleting a data item, the other application programs should apply a corresponding change to the remaining data sets. Between a server and client employing the SyncML protocol, changes in data may cause frequent data communication for data synchronization, increasing network traffic. The SyncML protocol can be based on XML text for interoperability in heterogeneous environments. The present invention is described with regard to a communication environment wherein a server and client communicate with each other according to the SyncML protocol, which is a text-based protocol that may increase processing load and network traffic during data communication. However, the present invention is not limited to the above case, and is applicable to any communication environment where a text-based protocol is utilized.

FIG. 1 illustrates a block diagram of a protocol hierarchy according to an exemplary embodiment of the present invention.

In FIG. 1, a server 170 managing a database provides data to clients on the network, and a client 100 sends a data request made by a user to the server 170 and delivers data obtained from the database to the user. Normally, a protocol stack in the client 100 is symmetrical with that in the server 170. To be more specific, when the user of an application running on the application layer 110 inputs data to be delivered to the server 170, the application layer 110 forwards the input data to the transport layer 120, which then encapsulates the input data into units of data suitable for transmission such as messages or packets. Here, the application layer 110 may include an application protocol 112 usable by an application, and a smart protocol 114 for performing data compression by eliminating repeated items in the data. In the description, data compression refers to reduction of the amount of data (data size reduction).

The transport layer 120 encapsulates input data from the application layer 110 into units of data in a transport format. The transport layer 120 in FIG. 1 is configured to include the HyperText Transfer Protocol (HTTP) 122, Transmission Control Protocol (TCP)/User Datagram Protocol (UDP) 124, and Internet Protocol (IP) 126. However, the transport layer 120 is not limited to these protocols. The SyncML protocol is applicable to both wired and wireless networks, and is interoperable with various transport protocols including HTTP, TCP/UDP, IP (as illustrated in FIG. 1), Wireless Application Protocol (WAP), Wireless Session Protocol (WSP), Universal Serial Bus (USB), OBject Exchange (OBEX) for RS-232 links, and Bluetooth for short-range radio frequency communication.

The physical layer 130 transmits data from the transport layer 120 through a wired or wireless channel to the physical layer 160 at the server 170. Transmitted data can be structured according to a format specified by an employed protocol. In the present invention, transmitted data can be structured in packages as specified by the SyncML protocol. A SyncML package can include one or more messages, a message includes a header and body, and the body can include one or more commands.

The server 170 can receive data from the client 100 through the physical layer 160. In the server 170, the user data from the client 100 can be restored through the transport layer 150 and application layer 140. As in the case of the client 100, the application layer 140 can include an application protocol 142 and a smart protocol 144, and the transport layer 150 can include HTTP 152, TCP/UDP 154 and IP 156. The application layer 140 and transport layer 150 of the server 170 can correspond respectively to the application layer 110 and transport layer 120 of the client 100, and a more detailed description thereof will not be given.

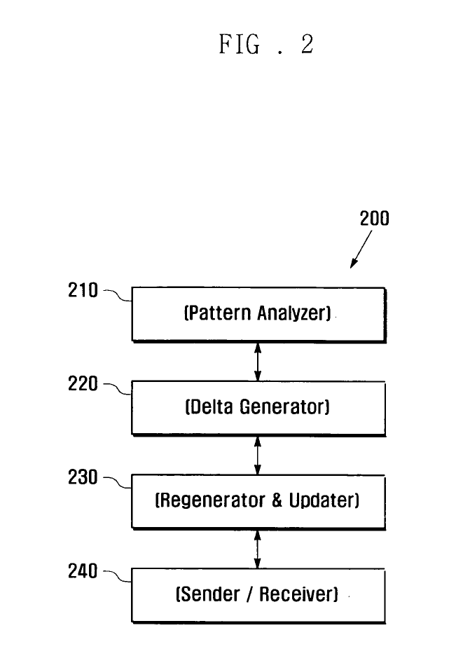

FIG. 2 illustrates a block diagram of a smart protocol unit 200 driving the smart protocol 114 at either the client or the server in FIG. 2.

Referring to FIG. 2, the smart protocol unit 200 can include a pattern analyzer 210, a delta generator 220, a regenerator/updater 230, and a sender/receiver 240. First, the smart protocol unit 200 at the sender sending data to a receiver is described.

Upon reception of input data, the pattern analyzer 210 can analyze the input data to identify the type or pattern thereof and convert the input data into a form usable for the smart protocol. The delta generator 220 can compare the data (current data) from the pattern analyzer 210 with the previously sent data, and create delta data by removing items of the current data identical to those of the previously sent data (i.e., eliminates repetitive data items). Here, the previously sent data refers to the data sent immediately before the current data or to the data having been sent a preset duration prior to the current data, depending upon settings. Additionally, depending upon the settings for the previously sent data, the data sent immediately before the current data, or the data having been sent a preset duration prior to the current data, is stored in a storage unit (not shown). The delta generator 220 can check the type of data to be sent, and create, if the type is a known type, delta data corresponding to the known type. To achieve this, information regarding known data types may be stored in advance. For the purpose of description, delta data is created by removing repeated items from the previously sent data (that is, delta data is composed of new or updated data items).

Upon reception of delta data from the delta generator 220, the regenerator/updater 230 checks whether update information on the employed protocol (i.e., SyncML protocol) is present, and updates the employed protocol if update information is present. The regenerator/updater 230 checks whether the input delta data is listed in index information. If the input delta data is listed in the index information, the regenerator/updater 230 represents the input delta data using a matching index of the index information. Here, the index information records the index of previously sent delta data, and is updated and stored in the storage unit whenever delta data is saved. When the employed protocol is to be updated, the regenerator/updater 230 can receive and save update information in advance through communication between the client 100 and server 170. The sender/receiver 240 can forward the created delta data to the transport layer 120 or 150, which encapsulates the delta data into units of data in the transport format. As a result, in the present invention, only changed or updated data is transmitted after repeated data items are removed, thereby reducing network traffic caused by the use of a text-based protocol.

Next, the smart protocol unit 200 at the receiver receiving data is described. For the purpose of description, it is assumed that the same reference symbols are used for the smart protocol unit 200 at the sender and receiver. The sender/receiver 240 receives data from the transport layer 120 or 150. The regenerator/updater 230 can check whether an index is present in the received data. If an index is present in the received data, the regenerator/updater 230 replaces the index with matching delta data, and forwards the received data in a restored form to the delta generator 220. If an index is not present in the received data, the regenerator/updater 230 forwards the received data to the delta generator 220. The delta generator 220 checks whether delta data is present in the received data. If delta data is present, the delta generator 220 restores the original data from the delta data. If delta data is not present, the delta generator 220 forwards the received data to the pattern analyzer 210. The pattern analyzer 210 recovers the original pattern (i.e., a pattern usable by the upper layer protocol) of the received data.

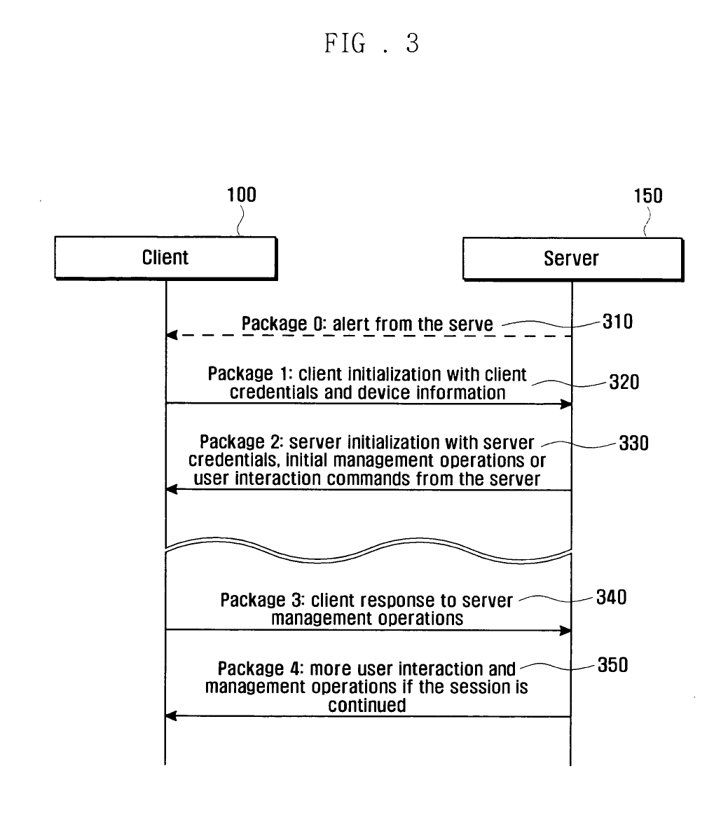

FIG. 3 illustrates a sequence diagram for a procedure for data communication between the server 170 and client 100.

Referring to FIG. 3, when the server 170 has data to be sent to the client 100, the server 170 can send an alert message (package 0) 310 notifying the client 100 of the presence of new data. The message of package 0 is illustrated in Table 1.

TABLE 1

<Alert>

<CmdID>3456</CmdID>
<Cred>

<Meta>

<Type

xmlns=“syncml:metinf”>syncml:auth-md5</Type>

<Format xmlns=“syncml:metinf”>b64</Format>

</Meta>

</Cred>
<Data>100</Data>
<Item>

<Data>You have new mail</Data>

</Item>

</Alert>

The message illustrated in Table 1 is an alert message (alert type 100) written, in XML, and is a notification message that is transmitted when the server 170 has a piece of data to be sent to the client 100.

Upon reception of the alert message, the client sends a message (package 1) 320 containing identification information (such as a phone number or address) and credentials to the server 170. After verification of the contents of the message from the client 100, the server 170 sends the data using the phone number or address present in the message 330 to the client 100. When data to be sent to the server 170 is present or a command is received from the server 170, the client 100 composes a corresponding message (package 3) 340 and sends the composed message to the server 170. In return, the server 170 sends a message (package 4) 350 containing requested data or commands to the client 100. As illustrated in FIG. 3, messages exchanged between the client 100 and server 170 are written in text (i.e., XML). The size of a text message tends to be large as illustrated by the message in Table 1 and Table 2 (below).

TABLE 2
<SyncML xmlns=′SYNCML:SYNCML 1.2″ >

<SyncHdr>
<VerDTD>1.2</VerDTD>
<VerProto>DM/1.2</VerProto>
<SessionID>1</SessionID>
<MsgID>1</MsgID>
<Target><LocURI>IMEI:493005100592800</LocURI></Target>
<Source><LocURI>http://www.syncml.org/mgmt-server</LocUR

I></Source>

</SyncHdr>
<SyncBody>
<Status>
<CmdID>1</CmdID>
<MsgRef>1</MsgRef>
<CmdRef>0</CmdRef>
<Cmd>SyncHdr</Cmd>
<TargetRef>http://www.syncml.org/mgmt-server</TargetRef>
<SourceRef>IMEI:493005100592800</SourceRef>

<Chal>
<Meta>

<Type xmlns=″syncml:metinf″>syncml:auth-basic</Type>
<Format xmlns=″syncml:metinf″>b64</Format>

</Meta>

</Chal>
<Data>407</Data> <!--Credentials Missing-->
</Status>

...

</SyncBody>

</SyncML>

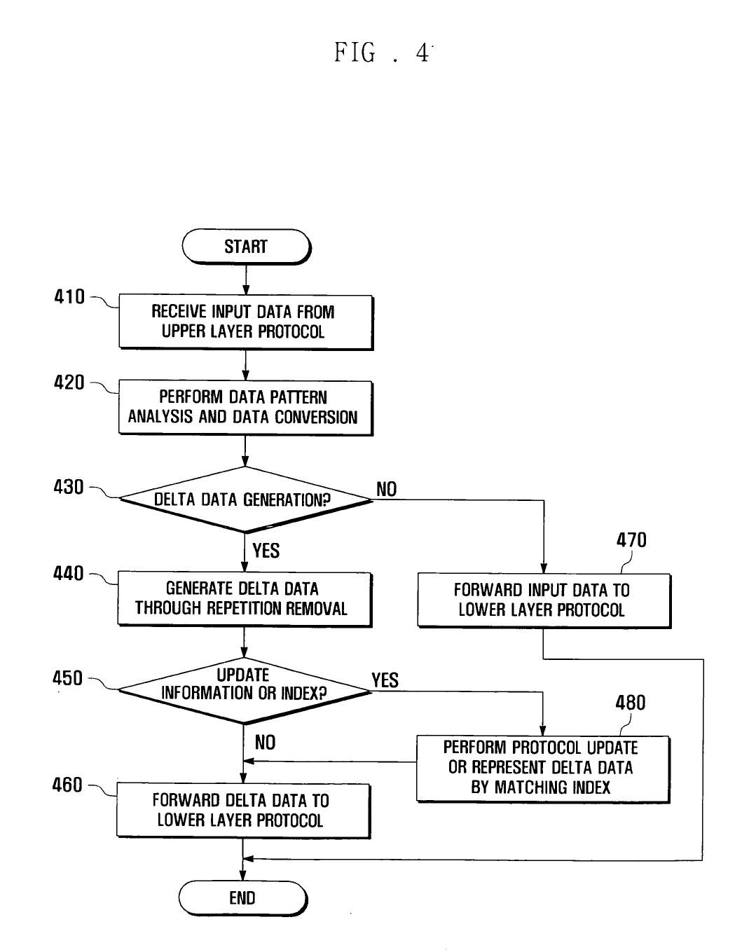

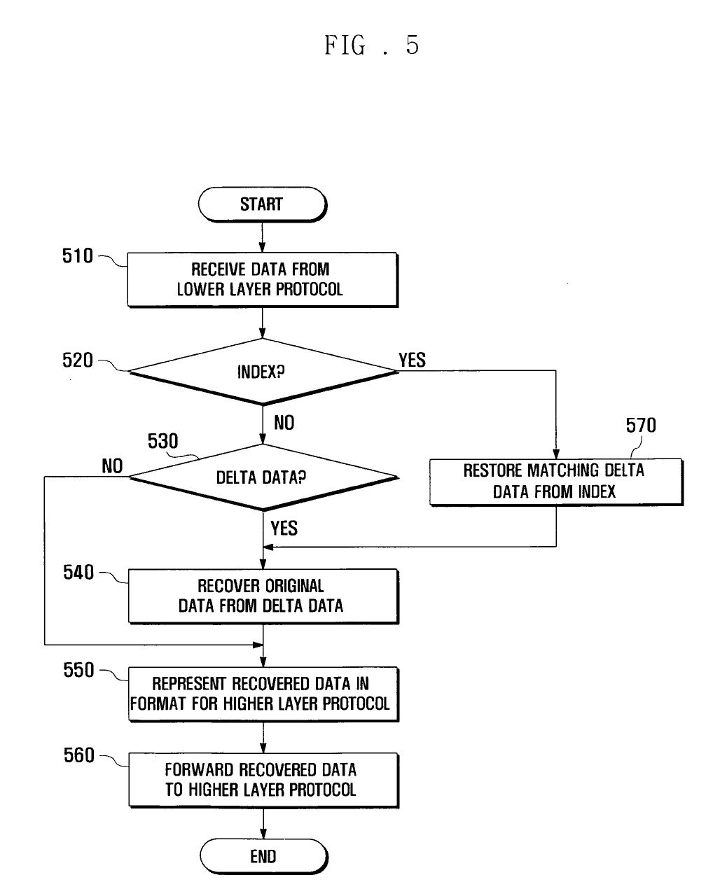

As shown in Table 1 and Table 2, the size of messages written in XML is large because of character coding. The present invention attempts to reduce the data size by transmitting only new or updated data items without sending repeated data items. The data size further can be reduced by representing the new or updated data items by their indexes if possible. This data size reduction is described in connection with FIGS. 4 and 5.

FIG. 4 illustrates a flow chart for a procedure of data compression performed by the smart protocol unit at the sender.

Referring to FIG. 4, the pattern analyzer 210 of the smart protocol unit 200 can receive input data from the upper layer protocol (block 410), analyze the input data to identify the type or pattern thereof, and convert the input data into a form usable for the smart protocol (block 420). To determine whether to generate delta data, the delta generator 220 can compare the input data (current data) with the previously sent data to find data items repeated in the current data and previously sent data (430).

If repeated data items are found, the delta generator 220 can eliminate the repeated data items from the current data to thereby produce delta data (block 440). Thereafter, the regenerator/updater 230 checks whether protocol update information is present or the produced delta data is listed on index information (block 450). Here, the index information records the index of previously sent delta data. When delta data is sent, the index of the delta data can be added to the existing index information. If protocol update information is present or the produced delta data is listed on index information, the regenerator/updater 230 updates the employed protocol or represents the delta data by a matching index of the index information (block 480), and proceeds to step 460. If protocol update information is not present and the produced delta data is not listed in index information, the regenerator/updater 230 can proceed directly to block 460. Then, the delta generator 220 forwards the delta data through the sender/receiver 240 to the lower layer protocol (transport layer), which converts the delta data into a transport format (block 460).

If no repeated data items are found at block 430, the delta generator 220 forwards the input data through the sender/receiver 240 to the lower layer protocol, which converts the input data into a transport format (block 470).

FIG. 5 illustrates a flow chart for a procedure for data restoration performed by the smart protocol unit at the receiver.

Referring to FIG. 5, the regenerator/updater 230 receives data through the sender/receiver 240 from the lower layer protocol (block 510), and checks whether an index is present in the received data (block 520). If an index is present in the received data, the regenerator/updater 230 restores matching delta data from the index (block 570), and proceeds to block 540. If an index is not present in the received data, the delta generator 220 checks whether delta data is present in the received data (block 530).

If delta data is not present in the received data, the delta generator 220 proceeds to block 550. If delta data is present in the received data, the delta generator 220 restores the original data from the delta data (block 540). The pattern analyzer 210 recovers the original pattern of the received data usable by the upper layer protocol (block 550), and forwards the recovered data to the upper layer protocol (block 560).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A data compression method comprising:
comparing, in response to input of data to be sent using a text-based protocol, the input data with previously sent data in storage; and
producing, when a data item repeated in the input data and previously sent data is found, a delta data by excluding the repeated data item from the input data.

2. The data compression method of claim 1, further comprising:
checking whether the produced delta data is listed in index information; and
representing, when the produced delta data is listed in the index information, the delta data by a matching index of the index information.

3. The data compression method of claim 2, further comprising:
checking whether protocol update information is present; and
updating, when protocol update information is present, a protocol associated with the protocol update information.

4. The data compression method of claim 1, further comprising:
analyzing, before comparing, the pattern of the input data; and
converting the input data into a form usable for a delta data protocol.

5. The data compression method of claim 1, wherein the text-based protocol is based on SyncML (Synchronization Markup Language).

6. A data communication system comprising:
a sender apparatus configured to compare, in response to input of data to be sent, the input data with a previously sent data in storage, wherein the sender apparatus further is configured to produce, when a data item repeated in the input data and previously sent data is found, a delta data by excluding the repeated data item from the input data, represent the delta data in a transport format, and transmit the delta data; and
a receiver apparatus configured to receive data in a transport format, the receiver apparatus configured to add, when delta data is present in the received data, a repeated data item to the delta data, and recover an original data,
wherein the sender apparatus sends and receives data to and from the receiver apparatus through a text-based protocol.

7. The data communication system of claim 6, wherein the sender apparatus checks whether the produced delta data is listed in index information, and represents, when the produced delta data is listed in the index information, the delta data by a matching index of the index information.

8. The data communication system of claim 6, wherein the receiver apparatus restores, when an index is present in the received data, matching delta data from the index on the basis of stored index information.

9. The data communication system of claim 6, wherein the sender apparatus checks whether protocol update information is present after delta data production, and updates, when protocol update information is present, a protocol associated with the protocol update information.

10. The data communication system of claim 6, wherein the sender apparatus analyzes the pattern of the input data before comparison, and converts the input data into a form usable for a delta data protocol.

11. The data communication system of claim 6, wherein the text-based protocol is based on SyncML (Synchronization Markup Language).

12. The data communication system of claim 6, wherein the sender apparatus is a server and the receiver apparatus is a client.

13. The data communication system of claim 6, wherein the sender apparatus is a client and the receiver apparatus is a server.

14. The data communication system of claim 10, wherein an application on the sender apparatus and another application on the receiver apparatus communicate with each other through a multi-layer protocol stack, and the delta data protocol resides in the application layer of the multi-layer protocol stack.

15. The data communication system of claim 14, wherein the application layer comprises an application protocol and the delta data protocol below the application protocol.

16. A data communication apparatus comprising:
a pattern analyzer configured to analyze input data to identify a type or pattern;
a delta generator configured to compare the input data received from the pattern analyzer with a previously sent data, wherein the delta generator further is configured to produce, when a data item repeated in the input data and previously sent data is found, a delta data by excluding the repeated data item from the input data, represent the delta data in a transport format; and
a transmitter configured to transmit the delta data through a text-based protocol.

17. The apparatus of claim 16, further comprising a regenerator/updater configured to check whether update information on an employed protocol is present.

18. The apparatus of claim 17, wherein the regenerator/updater is configured to update the protocol when update information is present.

19. The apparatus of claim 16, wherein the delta generator is configured to check whether the produced delta data is listed in index information, and represents, when the produced delta data is listed in the index information, the delta data by a matching index of the index information.

20. The apparatus of claim 16, wherein the pattern analyzer converts the input data into a form usable for a delta data protocol.
